(19) United States
(12) Patent Application Publication
(10) Pub. No.: US 2007/0225096 A1
(43) Pub. Date: Sep. 27, 2007

(54) Liquid crystal device and electronic apparatus

(75) Inventor: Shin Fujita, Suwa-shi (JP)

Correspondence Address: OLIFF & BERRIDGE, PLC, P.O. BOX 19928, ALEXANDRIA, VA, 22320, US

(73) Assignee: EPSON IMAGING DEVICES CORPORATION, NAGANO (JP)

(21) Appl. No.: 11/703,763

(22) Filed: Feb. 8, 2007

(30) Foreign Application Priority Data
Mar. 17, 2006 (JP) 2006-074774

(51) Int. Cl. F16G 1/28; G02F 1/1343

(52) U.S. Cl. 474/202; 349/139

(57) ABSTRACT

1. A liquid crystal device includes a substrate including unit pixels each composed of a plurality of sub pixels arranged in a plurality of rows and one column and having a long side in the row direction and a short side in the column direction, wherein the substrate includes switching elements, an insulating film provided on at least the upper side of each of the switching elements, at least one first transparent electrodes provided on the upper side of the insulating film, other insulating film provided on the upper side of the first transparent electrodes, and at least one second transparent electrode formed on the upper side of the other insulating film and having a plurality of slits formed for each of the sub pixels and generating an electric field, the electric field being generated between the first transparent electrode and the second transparent electrode through each of the slits, and the extending direction of the long side of each of the slits is defined in a direction not the same as the extending direction of the short side of the sub pixels.

### BACKGROUND

1. Technical Field

The present invention relates to a liquid crystal device and an electronic apparatus preferably used for displaying a variety of information.

2. Related Art

Display modes of liquid crystal are typically broadly classified into a TN (Twisted Nematic) system, a vertical alignment system intended to provide a wide viewing angle and a high contrast, a lateral electric field system, an example of witch is an IPS (In-Plane Switching) system or an FFS system (Fringe Field Switching), and the like.

Among these systems, in the IPS system, the direction of an electric field applied to liquid crystal is defined in a direction approximately parallel to a substrate, so that this system is advantageous in that the viewing angle characteristic can be improved as compared with the TN system and the like.

However, in such a liquid crystal device, a pixel electrode made of a transparent conductive material such as ITO (Indium Tin Oxide) and a common electrode generating a lateral electric field, the lateral electric field being generated between the pixel electrode and the common electrode, are generally provided in the same layer. For this reason, there is a problem in that liquid crystal molecules positioned in the upper side of the pixel electrode are not sufficiently driven, thereby reducing transmittance and the like.

In this regard, the layer in which the common electrode is formed is provided at the lower side of the layer in which an image electrode is formed in the FFS system. Consequently, a lateral electric field can be applied to the liquid crystal molecules positioned at the upper side of the image electrode and the liquid crystal molecules existing at that position can be fully driven. As a result, there are advantages that improvement of transmittance and the like can be realized as compared with the above mentioned IPS system.

An example of a liquid crystal device of the FFS system is described in JP-A-2001-235763 (hereinafter, referred to as “Patent Document 1”) and JP-A-2002-182230 (hereinafter, referred to as “Patent Document 2”).

Here, both liquid crystal devices described in Patent Document 1 and Patent Document 2 are examples of an FFS-system liquid crystal device applying an α-Si (amorphous-silicon) type TFT element. In addition, in the liquid crystal device described in Patent Document 2, an image electrode is formed in a vertically extended shape (vertical stripe shape) having a long side in the extending direction of a data bus line and having a short side in the extending direction of a gate bus line. In the pixel electrode, a plurality of slits for generating a fringe field (lateral direction electric field) are provided, the fringe field being generated between the pixel electrode and a counter electrode (common electrode) formed at the lower layer thereof.

In the liquid crystal device described in Patent Document 2, a pixel electrode is formed in a vertical stripe shape and each slit is arranged to have a predetermined declination so as to be symmetric with respect to the center of the long side direction of the pixel electrode, so that many slits are provided in the structure.

Here, in the case of the general FFS system liquid crystal device, the way in which a fringe field is applied is altered in the vicinity of one end among the two ends of the long side direction of the slit provided in a pixel electrode as compared with positions which are not in the vicinity of the ends of each slit when liquid crystal is driven, which generates a portion of a domain area (alignment abnormal area of liquid crystal) in which liquid crystal molecules are negligibly driven. Therefore, the brightness is deteriorated in the domain area resulting in a dark display area. Note that, the domain area is proportional to the number of slits set and occurs at an end of each of the slits in a staggered manner. Many slits are provided in the pixel structure of the liquid crystal device described in the Patent Document 2 described above. Accordingly, there is a problem in that the portion of the domain area which does not contribute to the brightness is increased and the transmittance of the liquid crystal device is seriously deteriorated as a result.

### SUMMARY

An advantage of some aspects of the invention is that it provides a liquid crystal device of an FFS system having a pixel structure which makes it possible to reduce a portion of a domain area that results in deterioration of transmittance, and an electronic apparatus using the same.

According to an aspect of the invention, a liquid crystal device includes a substrate including unit pixels each composed of a plurality of sub pixels arranged in a plurality of rows and one column and having a long side in the row direction and a short side in the column direction. Further, the substrate includes switching elements, an insulating film provided on at least the upper side of each of the switching elements, at least one first transparent electrodes provided on the upper side of the insulating film, other insulating film provided on the upper side of the first transparent electrodes, and at least one second transparent electrode formed on the upper side of the other insulating film and having a plurality of slits formed for each of the sub pixels and generating an electric field, the electric field being generated between the first transparent electrode and the second transparent electrode through each of the slits. Further, the extending direction of the long side of each of the slits is defined in a direction not the same as the extending direction of the short side of the sub pixels.

The liquid crystal device described above includes a substrate including unit pixels each composed of a plurality of sub pixels arranged in a plurality of rows and one column and having a long side in the row direction and a short side in the column direction. Accordingly, each sub pixel is formed in a horizontally extended rectangle (horizontal stripe shape) having a long side in the row (lateral) direction. The substrate includes switching elements, an insulating film provided on at least the upper side of each of the switching element and formed of, for example, transparent acrylate resin or the like, at least one first transparent electrodes provided on the upper side of the insulating film, other insulating film provided on the upper side of the first transparent electrodes and formed of, for example, SiO₂, SiNₓ (silicon nitride film) or the like, and at least one second transparent electrode formed on the upper side of the other insulating film and having a plurality of slits formed for each of the sub pixels and generating an electric field, the electric field being generated between the first transparent electrode and the second transparent electrode through each of the slits. In a preferred example, the electric field can be a fringe field having strong electric field components in the direction approximately parallel to and in the direction approximately perpendicular (the upper direction of the substrate) to the substrate. Herewith, an FFS type liquid crystal device can be constructed.

In a preferred example, as for the switching element, a three terminal type element, examples of which are, for example, an LTPS (Low-Temperature Poly-Silicon) type TFT element manufactured at a temperature not more than 600° C. on a glass substrate, a P-Si (poly-silicon) type TFT element, an α-Si (amorphous-silicon) type TFT element, or the like or a two terminal type non-linear element, examples of which are a TFD (Thin Film Diode) element and the like can be used.

Here, suppose a comparative example where the extending direction of the long side of each slit provided in the second transparent electrode is defined in the direction which is the same as the extending direction of the short side of the sub pixel, the slits needs to be evenly provided on the entire sub pixel in order to appropriately drive the liquid crystal by using the FFS system. Accordingly, the slit needs to be provided so as to align at a proper position in the long side of the sub pixel in the comparative example, so that the setting number of the slit is increased as a result. Further, in the case of the general FFS system liquid crystal device, the way in which a fringe field is applied is altered in the vicinity of one end among the two ends of the long side direction of the slit as compared with positions which are not in the vicinity of the ends of each slit when liquid crystal is driven, which generates a portion of a domain area (alignment abnormal area of liquid crystal) in which liquid crystal molecules are negligibly driven. Therefore, brightness is deteriorated in the domain area resulting in a dark display area. Note that, the domain area is proportional to the setting number of slits set and occurs at an end of each of the slits in a staggered manner. Accordingly, there is a problem in that the number of the portion of the domain area which does not contribute to the brightness is increased as the number of the slit provided in each of the sub pixels is increased as in the comparative example described above and the transmittance of the liquid crystal device is seriously deteriorated as a result.

In this regard, in the liquid crystal device, the extending direction of the long side of each of the slits provided in the second transparent electrode is defined in a direction not the same as the extending direction of the short side of the sub pixel. In a preferred example, it is preferable that the extending direction of the long side of the slits is defined in the same direction as the extending direction of the long side of the sub pixels or in a direction making a predetermined angle with respect to the extending direction of the long side of the sub pixels.

Therefore, the slits provided in the second transparent electrode are formed in an elongated shape as compared with the comparative example described above. Accordingly, the setting number of the slit can be reduced in the state where the slits are evenly arranged in the entire second transparent electrode as compared with the comparative example described above. A domain area occurs in the vicinity of any one end among the two ends of the long side direction of each of the slits also in the liquid crystal device during liquid crystal is driven. However, the setting number of the slits provided in the second transparent electrode is being reduced as compared with the comparative example described above, so that a portion of the domain area can be reduced in accordance with the reduction. As a result, the deterioration of the transmittance can be prevented.

In a preferred example, it is preferable that the liquid crystal device includes a plurality of first lines extending in the column direction and a plurality of second lines extending in the row direction which are electrically connected to the switching elements. The extending direction of the long side of the each slit is defined in the same direction as the extending direction of the plurality of second lines or in a direction making a predetermined angle with respect to the extending direction of the plurality of second lines. Note that the first lines can be data lines to which an image signal is supplied or gate lines to which a scanning signal is supplied, and in correspond to this, the second lines can be gate lines to which a scanning signal is supplied or data lines to which an image signal is supplied.

In one aspect of the liquid crystal device described above, the first transparent electrode is a common electrode connected to a common electric potential and the second transparent electrode is a unit sub pixel electrode formed for each of the sub pixels and electrically connected to the switching element via a contact hole provided in each of the insulating layer and the other insulating layer.

In this aspect, the first transparent electrode can be a common electrode connected to a common electric potential, and the second transparent electrode can be a unit sub pixel electrodes formed for each of the sub pixels and electrically connected to the switching element via a contact hole provided in each of the insulating film and the other insulating film.

In another aspect of the liquid crystal device described above, the first transparent electrode is a unit sub pixel electrode formed for each of the sub pixels and electrically connected to the switching element via a contact hole provided in the insulating film, and the second transparent electrode is a common electrode connected to a common electric potential.

In this aspect, the first transparent electrode can be a unit sub pixel electrode formed for each of the sub pixels and electrically connected to the switching element via a contact hole provided in the insulating film, and the second transparent electrode can be a common electrode connected to a common electric potential.

In another aspect of the liquid crystal device described above, the plurality of first lines are a plurality of source lines electrically connected to a signal line driving circuit and to which an image signal is supplied from the signal line driving circuit, and the plurality of second lines are a plurality of gate lines electrically connected to a scanning line driving circuit and to which a scanning signal is supplied from the scanning line driving circuit. Further, each of the sub pixels constituting the unit pixels is electrically connected to a corresponding one of the gate lines and electrically commonly connected to one of the source lines. Further, the scanning line driving circuit drives the unit pixels by sequentially scanning each of the gate lines electrically connected to each of the sub pixels during one horizontal scanning period.

In this aspect, the plurality of first lines can be a plurality of source lines electrically connected to a signal line driving circuit and to which an image signal is supplied from the signal line driving circuit. On the other hand, the plurality of second lines can be a plurality of gate lines electrically connected to a scanning line driving circuit and to which a scanning signal is supplied from the scanning line driving circuit. Further, each of the sub pixels constituting a unit pixel is electrically connected to a corresponding one of the gate lines and electrically commonly connected to one source line. Further, the scanning line driving circuit drives unit pixels by sequentially scanning each of the gate lines electrically connected to each of the sub pixels during one horizontal scanning period (1H period).

Therefore, effects can be achieved as described below. For example, in the case where a unit pixel is composed of a plurality of sub pixels arranged in N (any positive integer, hereinafter the same) rows and one column and having a long side in the row direction and having a short side in the column direction, N sub pixels in a unit pixel are sequentially driven (that is, N times scanning) during one horizontal scanning period by the scanning line driving circuit and an image signal is supplied to each of the sub pixels from a same source line. Therefore, the unit pixel is driven at N times of driving duty as compared with the liquid crystal device of conventional type. As a result, improvement of display quality can be provided. Here, the liquid crystal device of conventional type refers to a liquid crystal device in which a unit pixel is composed of a plurality of sub pixels arranged in one row and N columns and equipped with a structure in which each of sub pixels is electrically commonly connected to one gate line and is electrically connected to a corresponding one of the N source lines in the unit pixel. In such liquid crystal device, N sub pixels in a unit pixel are scanned by one gate line during one horizontal scanning period (1H period) and an image signal is supplied to each of the sub pixels from each of the N source lines connected thereto.

According to another aspect of the invention, an electronic apparatus provided with the liquid crystal device described above as a display unit can be constructed.

### BRIEF DESCRIPTION OF THE DRAWINGS

The invention will be described with reference to the accompanying drawings, wherein like numbers reference like elements.

FIG. 1 a plan view schematically showing a structure of a liquid crystal device according to a first embodiment of the invention.

FIG. 2A is an enlarged plan view showing a pixel structure and the like according to the first embodiment.

FIG. 2B is an enlarged plan view showing a pixel structure and the like according to a second embodiment.

FIG. 3 is a main portion cross-sectional view including a sub pixel according to the first embodiment.

FIG. 4 is a main portion cross-sectional view including a sub pixel according to the second embodiment.

FIG. 5 is a block diagram showing an electric equivalent circuit of the liquid crystal device according to the first embodiment.

FIG. 6 is a timing chart according to a driving method of the liquid crystal device of the first embodiment.

FIG. 7A is an enlarged plan view showing a pixel structure according to a first comparative example.

FIG. 7B is a main portion cross-sectional view according to the first comparative example.

FIG. 8 is an enlarged plan view showing a pixel structure according to a second comparative example.

FIGS. 9A and 9B are each an enlarged plan view showing a pixel structure and the like according to various modifications.

FIG. 10 is a plan view schematically showing a structure of another liquid crystal device according to a modification.

FIGS. 11A and 11B are each an example of the electronic apparatus to which the liquid crystal device of the invention is applied.

### DESCRIPTION OF EXEMPLARY EMBODIMENTS

Hereinafter, preferred embodiments of the invention will be described with reference to the attached drawings. It should be noted here that the invention is applied to a liquid crystal device in various embodiments described below. Note that the phrase “on the inner surface” has the meaning of on the inner surface positioned on the liquid crystal 4 side. Therefore, for example, “on the inner surface of the element substrate” means on the inner surface of the element substrate positioned on the liquid crystal 4 side.

### First Embodiment

### Structure of Liquid Crystal Device

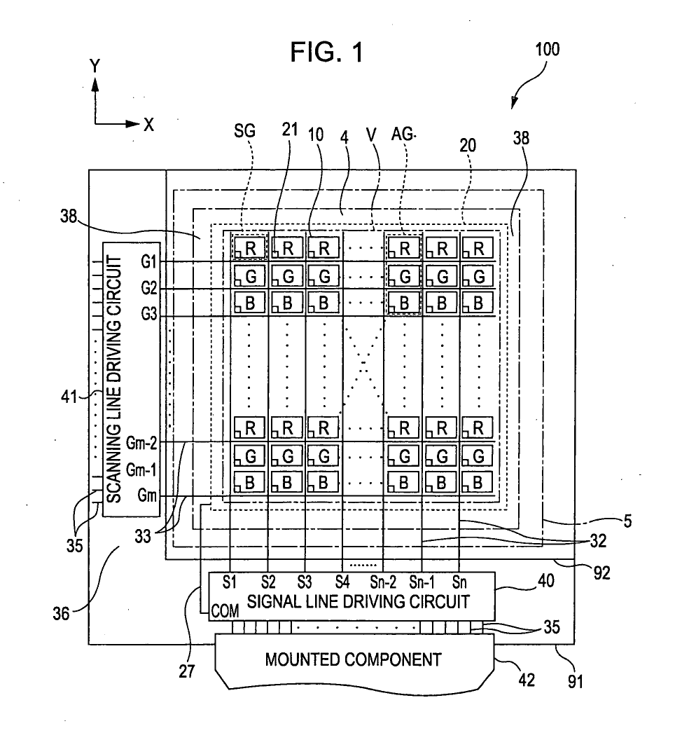

First, a structure of a liquid crystal device 100 according to a first embodiment of the invention will be described with reference to FIG. 1.

FIG. 1 is a plan view schematically showing a structure of the liquid crystal device 100 according to the first embodiment of the invention. A color filter substrate 92 is disposed at the front side of the plane of FIG. 1 (observation side), on the other hand, an element substrate 91 is disposed at the back side of the plane of FIG. 1. Note that the longitudinal direction of the figure (column direction) is defined as a Y direction and the lateral direction of the figure is defined as an X direction (row direction). Moreover, in FIG. 1, a region corresponding to one of an R, G, or B color is defined as one sub pixel area SG and one pixel area AG is composed of one of each R, G, and B color sub pixel areas AG aligned in one column and taking up three rows. Here, each sub pixel area SG is a horizontally extended rectangular area having a long side in the row direction and having a short side in the column direction. The long side direction of each sub pixel area SG is defined in the extending direction of the gate lines 33, on the other hand, the short side direction of each sub pixel area SG is defined in the extending direction of the source lines 32. Note that hereinafter, one display area existing in one sub pixel area SG may be referred to as a “sub pixel” and a display area corresponding to one pixel area AG may be referred to as a “unit pixel”

In the liquid crystal device 100, the element substrate 91 is bonded to the color filter substrate 92 disposed to face the element substrate 91 with a frame shaped sealant 5 therebetween, and liquid crystal is then sealed therebetween to form a liquid crystal layer 4.

Here, the liquid crystal device 100 is a liquid crystal device for color display constructed using sub pixels of three colors R, G, and B, and is a liquid crystal device of active matrix driving system using an LTPS (low-temperature poly-silicon) type TFT element manufactured at a temperature under 600° C. on a first substrate 1 to be described below as a switching element and having a double gate structure (hereinafter, referred to as “LTPS type TFT element 21”). Further, the liquid crystal device 100 is a so-called FFS system liquid crystal device which controls the alignment of liquid crystal molecules by generating a fringe field (electric field E) in a direction approximately parallel to and approximately perpendicular (observation side) to the element substrate 91 surface at the element substrate 91 side in which various electrodes such as a pixel electrode and the like are formed. Therefore, a wide viewing angle can be obtained for the liquid crystal device 100. Further, the liquid crystal device 100 is a transmissive type liquid crystal device for performing only transmissive type display.

First, a planar structure of the element substrate 91 is as described below.

On the inner surface of the element substrate 91, there are mainly mounted a plurality of source lines 32, a plurality of gate lines 33, a plurality of LTPS type TFT elements 21, a plurality of pixel electrodes 10, a common electrode 20, a signal line driving circuit 40, a scanning line driving circuit 41, exterior connecting lines 35, and a mounted component 42 such as a FPC (Flexible Printed Circuit) and the like.

As shown in FIG. 1, the element substrate 91 has an extending region 36 extending to the outside from each of two adjacent sides of the color filter substrate 92. The signal line driving circuit 40 is mounted on the extending region 36 outside of one side of the color filter substrate 92 and positioned in the Y direction. Further, the scanning line driving circuit 41 is mounted on the extending region 36 outside of another side of the color filter substrate 92 and positioned in the X direction. Each input side terminal (abbreviated in the drawings) of the signal line driving circuit 40 and the scanning line driving circuit 41 are electrically connected to one end side of the plurality of exterior connecting lines 35 and another end side of the plurality of exterior connecting lines 35 are electrically connected to the mounted component 42. Note that in FIG. 1, for the sake of convenience, the connecting state of the scanning line driving circuit 41 and the mounted component 42 via the exterior connecting lines 35 is omitted.

Each source line 32 is formed to extend in the Y direction at an appropriate position in the X direction. One end side of each source line 32 is electrically connected to output side terminals (abbreviated in the drawings) of the signal line driving circuit 40.

Each gate line 33 has a three layer structure of, for example, Ti (titanium)/Al (aluminum)/Ti (titanium) and is formed to extend in the X direction at an appropriate position in the Y direction and within a viewing area V. One end side of each gate line 33 is electrically connected to output side terminals (abbreviated in the drawings) of the scanning line driving circuit 41.

One of the LTPS type TFT elements 21 is provided in the vicinity of the crossing position of each source line 32 and each gate line 33. Each of the LTPS type TFT elements 21 is electrically connected to a corresponding one of the source lines 32, a corresponding one of the gate lines 33, each pixel electrode 10 and the like.

Each pixel electrode 10 is formed of a transparent conductive material such as, for example, ITO or the like and is provided so as to correspond to one of the sub pixel areas SG.

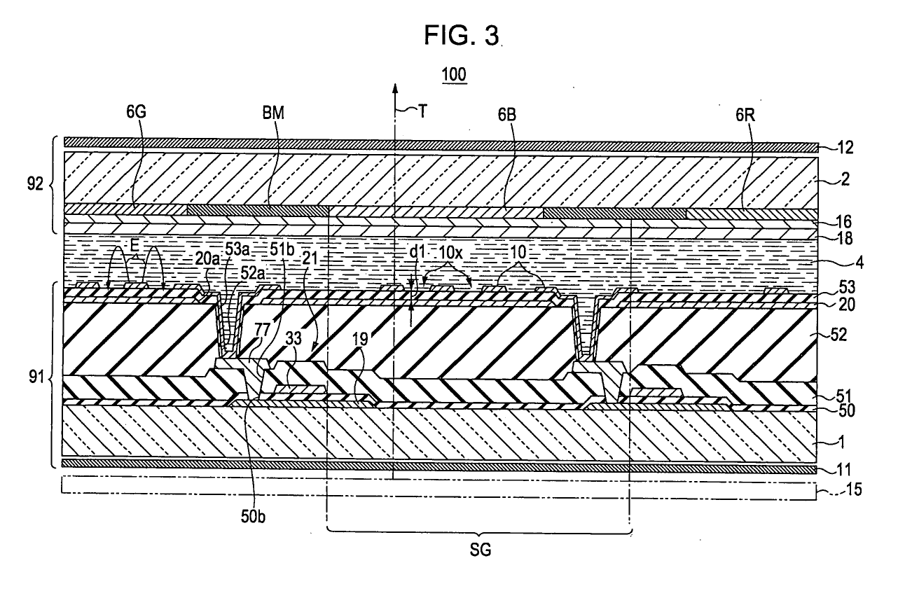

The common electrode 20 is formed of the same material as the pixel electrodes 10 and has approximately the same area as the viewing area V (the area surrounded by the thick dotted line), and is provided at the lower side of each pixel electrode 10 in an approximately fitted state to sandwich a third insulating film (dielectric film) 53 shown in FIG. 3. The common electrode 20 is electrically connected to, for example, a common electric potential terminal (COM terminal) in the signal line driving circuit 40 via a common line 27 made of the same material or the like as the common electrode 20.

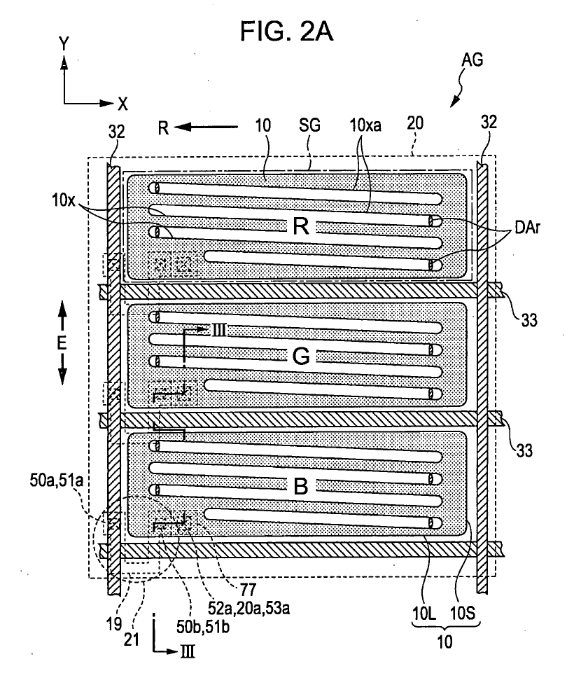

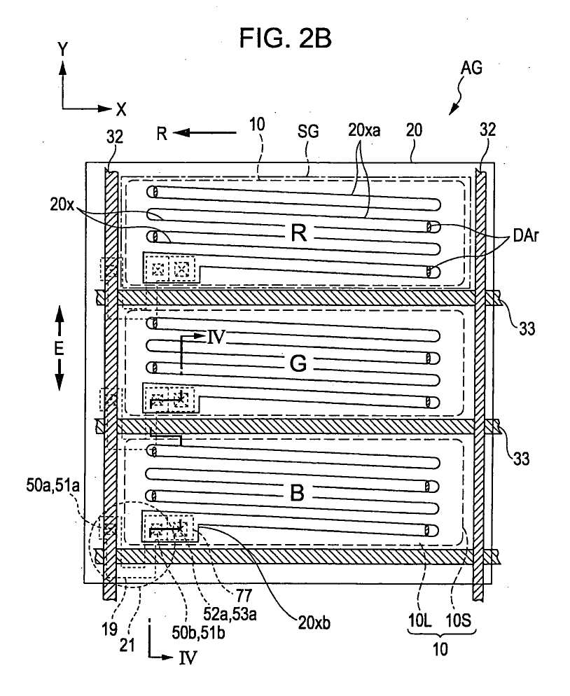

An area in which a plurality of pixel areas AG are aligned in the X and Y directions in a matrix is defined as the viewing area V (the area surrounded by two-dot chain line). Images such as characters, numbers, figures and the like are displayed in the viewing area V. Note that the outside region of the viewing area V is a frame region 38 which does not contribute to display. In addition, an alignment layer not shown in the drawings is formed on the inner surface of each of the pixel electrodes 10. The alignment layer is subjected to rubbing treatment in a predetermined direction R (see FIG. 2).

Next, a planar structure of the color filter substrate 92 will be described below.

The color filter substrate 92 includes light shielding layers (generally termed a “black matrix”, hereinafter simply abbreviated as “BM”), coloring layers 6R, 6G, 6B of three colors R, G, B, an overcoat layer 16, an alignment layer 18, and the like. It should be noted here that in the following description, when a coloring layer is specified regardless of the color thereof, the coloring layer is simply referred to as a “coloring layer 6”. When a coloring layer is distinctly specified by the color thereof, the coloring layer is referred to as a “coloring layer 6R” or the like. The BM is formed at the position so as to cover each sub pixel area SG.

In the liquid crystal device 100 having the structure described above, on the basis of a signal, an electric power, and the like, the gate lines 33 are sequentially selected in order of G₁, G₂, . . . , Gₘ₋₁, Gₘ (m: natural number) by the scanning line driving circuit 41 and the gate signal of selected voltage is supplied to the selected gate line 33. On the other hand, the gate signal of non-selected voltage is supplied to remaining non-selected gate lines 33. Then, the signal line driving circuit 40 supplies a source signal in accordance with a display content to the pixel electrode 10 existing at the position corresponding to the selected gate line 33 via the corresponding source line 32 S₁, S₂, . . . , Sₙ₋₁, or Sₙ (n: natural number) and the corresponding LTPS type TFT element 21. As a result, the display state of the liquid crystal layer 4 is shifted to a non-display state or an intermediate display state and the alignment state of the liquid crystal molecules in the liquid crystal layer 4 is controlled. This makes it possible to display a desired image in the viewing area V.

### Pixel Structure

Next, a pixel structure and the like of the liquid crystal device according to the first embodiment of the invention will be described with reference to FIGS. 2A and 3.

FIG. 2A shows a planar structure of one pixel in the element substrate 91 according to the first embodiment. Note that only the minimum number of elements needed for the description of the element substrate 91 are illustrated in FIG. 2A. FIG. 3 shows a cross-sectional view taken along the section line III-III in FIG. 2A and shows a cross-sectional structure containing one sub pixel which is cut so as to pass over the LTPS type TFT element 21.

First, a pixel structure and the like of the element substrate 91 of the first embodiment will be described.

A low-temperature type P-Si (poly-silicon) layer 19 having a flat surface shape of an approximately U character shape are formed on the inner surface of the first substrate 1 which is a glass substrate to intersect with respect to the gate line 33 twice so as to correspond to the crossover position of source line 32 and the gate line 33. A gate insulating film 50 made of, for example, SiO₂ or the like is formed on approximately the entire inner surface of the P-Si layer 19 and the first electrode 1.

The gate insulating film 50 has a first contact hole 50a at one end side of the P-Si layer 19 and at the positions which overlap a portion of the source line 32 in plan view, and has a second contact hole 50b at the position corresponding to another end side of the P-Si layer 19. Gate lines 33 are formed on the inner surface of the gate insulating film 50. The gate lines 33 are formed to extend in the X direction at a certain position in the Y direction as shown in FIG. 2A and partly overlap the P-Si layer 19 in plan view. Note that the length of the sub pixels in the extending direction of the source line 32 to be described below is greater than the length of the sub pixels in the extending direction of the gate line 33.

A first insulating film 51 which is transparent and made of, for example, SiO₂ or the like is formed on the inner surface of the gate lines 33 and the gate insulating film 50. The first insulating film 51 has a first contact hole 51a at a position corresponding to the first contact hole 50a and has a second contact hole 51b at a position corresponding to the second contact hole 50b. The source line 32 and a relay electrode 77 are provided on the inner surface of the first insulating film 51.

As shown in FIG. 2A, the source lines 32 are formed to extend in the Y direction at a certain position in the X direction. A portion of the source line 32 overlaps a portion of one end side of the P-Si layer 19 in plan view. A portion of the source line 32 is provided so as to intrude into the first contact holes 50a and 51a and the source line 32 is electrically connected to one end side of the P-Si layer 19. The relay electrode 77 overlaps a portion of another end side of the P-Si layer 19 in plan view. A portion of the relay electrode 77 is provided so as to intrude into the second contact holes 50b and 51b and the relay electrode 77 is electrically connected to another end side of the P-Si layer 19. For this reason, each source line 32 is electrically connected to a corresponding one of the relay electrodes 77 via the corresponding one of the P-Si layers 19. Thus, a double gate structure LTPS type TFT element 21 is provided at a position corresponding to each P-Si layer 19 and so as to correspond to the crossing position of the source line 32 and the gate line 33.

A second insulating film 52 made of, for example, transparent acrylate resin or the like is formed on the inner surface of the source lines 32, the relay electrodes 77, and the first insulating film 51. The inner surface of the second insulating film 52 is substantially flat and the second insulating film 52 constitutes a planarized film. The second insulating film 52 has a contact hole 52a at one end side of the relay electrode 77 and at a position in the vicinity of the second contact holes 50b and 51b. Note that in the invention, an insulating film made of, for example, SiNₓ (silicon nitride film) or the like may also be provided.

The common electrode 20 which is electrically connected to the COM terminal (common electric potential terminal) is formed over approximately the entire inner surface of the second insulating film 52 (also see FIG. 1). The common electrode 20 is formed of a transparent conductive material, for example, ITO or the like and has an aperture 20a at a position corresponding to the contact hole 52a. A third insulating film 53 made of, for example, SiO₂, SiNₓ or the like is formed on the inner surface of the portion of the second insulating film 52 positioned in the contact hole 52a and of the common electrode 20. The third insulating film 53 has a contact hole 53a at a position corresponding to the contact hole 52a of the second insulating film 52. The third insulating film 53 functions as a dielectric film forming a supplemental capacity as is provided between the common electrode 20 and the pixel electrode 10 to be described below. Here, it is preferable that the thickness d1 of the third insulating film 53 is set as small as possible in order to ensure a sufficient supplemental capacity.

In order to realize the object, in a preferred example, the thickness d1 of the third insulating film 53 is preferably determined so that the dimension of the supplemental capacity formed there is set in the range of about 100 to 600 fF, more preferably in the range of about 200 to 800 fF. Moreover, in the case where the definition is not less than 200 PPi, it is preferable that the thickness d1 of the third insulating film 53 is set in the range of about 50 to 400 nm. On the other hand, in the case where the definition is less than 200 PPi, it is preferable that the thickness dl of the third insulating film 53 is set in the range of about 200 to 1000 nm.

The pixel electrodes 10 made of a transparent conductive material, for example, ITO or the like are formed on the inner surface of the third insulating film 53 and in each sub pixel area SG. Each of the pixel electrodes 10 is formed to have approximately the same shape as the sub pixel area SG and is formed in a horizontally extended rectangular shape (horizontal stripe shape) having a long side 10L in the long side direction of the sub pixel area SG (X direction or row direction) and having a short side 10S in the short side direction of the sub pixel area SG (Y direction or column direction). Therefore, the direction of the long side 10L of the pixel electrodes 10 is defined in the extending direction of the gate line 33. On the other hand, the direction of the short side 10S of the pixel electrodes 10 is defined in the extending direction of the source line 32. The pixel electrode 10 is provided so as to intrude into the contact holes 52a and 53a and is electrically connected to the relay electrode 77 via the contact holes 52a and 53a. Therefore, a source signal (image signal) from the source line 32 is supplied to the pixel electrode 10 via the LTPS type TFT element 21 and the relay electrode 77. In addition, the pixel electrode 10 opposes the common electrode 20 through the third insulating film 53 and overlaps the common electrode 20 in plan view. A plurality of slits 10x for generating a fringe field (electric field E) between the pixel electrode 10 and the common electrode 20 are formed in the pixel electrode 10. Each slit 10x is formed in an elongated horizontal stripe shape. The extending direction of the long side 10xa of each slit 10x is defined in a direction which is not the same as the extending direction of the short side 10S of the pixel electrode 10 and the extending direction of the source line 32. Note that in the example, the short side (reference numeral is omitted) of each slit 10x which is linked to the long side 10xa of each slit 10x is formed to have a curved line shape. However, in the invention, the shape of the short side is not limited to this and may be, for example, a straight line shape. In the example, the extending direction of the long side 10xa of each slit 10x is defined in a direction making a predetermined angle with respect to the direction of the long side 10L of the pixel electrodes 10 and extending direction of the gate line 33. In this regard, the extending direction of the long side 10xa of each slit 10x may be defined in the same direction as the extending direction of the long side 10L of the pixel electrode 10 and the extending direction of the gate line 33.

An alignment layer not shown in the drawings is formed on a portion of the third insulating film 53 and the inner surface of the pixel electrodes 10. The alignment layer is subjected to rubbing treatment in the x direction (hereinafter referred to as “rubbing direction R”) which is the extending direction of the gate line 33 as shown in FIG. 2A. Accordingly, the liquid crystal molecules 4a are aligned in the state where the long axis direction thereof is in line with the rubbing direction R in an initial alignment state. Moreover, a polarizer 11 is provided on the lower side of the first substrate 1 and a backlight 15 as an illumination device is provided on the lower side of the polarizer plate 11. In this manner, the element substrate 91 including the pixel structure according to the first embodiment is constructed.

On the other hand, a structure of the color filter substrate 92 corresponding to the above described pixel structure will be described below.

A coloring layer 6 formed by any one of a red (R) coloring layer 6R, a green (G) coloring layer 6G, and a blue (B) coloring layer 6G is provided on the inner surface of a second substrate 2 which is a glass substrate and in one pixel area AG for every sub pixel area SG. Therefore, the arrangement direction of each coloring layer 6 of red (R), green (G), and blue (B) is defined in the extending direction of the source line 32. The BM is provided on the inner surface of the second substrate 2 and at the position for covering each sub pixel area SG and at a position corresponding to the LTPS type TFT element 21. Accordingly, the LTPS type TFT element 21, the source line 32, the gate line 33, and the like overlap the BM in plan view. An overcoat layer 16 is formed on the inner surface of the BM and each coloring layer 6. The overcoat layer 16 has a function of protecting the coloring layer 6 and the like from erosion and pollution caused by an agent or the like used during the manufacturing process of the liquid crystal device 100. The alignment layer 18 subjected to a rubbing treatment in a predetermined direction is formed on the inner surface of the overcoat layer 16. In this manner, the color filter substrate 92 according to the first embodiment is constructed.

In the liquid crystal device 100 having the structure described above, when being driven, the liquid crystal molecules (not shown in the drawings) in the initial alignment state in line with the rubbing direction R are rotated anticlockwise or clockwise by the fringe field (electric field E) generated in the extending direction of the source line 33 to be realigned in the extending direction of the source line 32. Note that in the cross-sectioned structure shown in FIG. 3, the fringe field (electric field E) has electric field strength components in the direction approximately parallel (lateral direction in the page) to and in the direction approximately perpendicular to the element substrate 91, and being generated between the pixel electrode 10 and the common electrode 20 through the plurality of slits 10x thereof and the third insulating film 53. Thereby, alignment control of the liquid crystal molecules is performed and transparent type display can be realized. Then, in the transparent display, the illumination light emitted from the backlight 15 proceeds along the path T to be shown in FIG. 3, passes through the common electrode 20, pixel electrode 10, each coloring layer 6 of R, B, and G and reaches an observer. In this case, the illumination light expresses a predetermined hue and brightness by being transmitting through the coloring layer 6. In this manner, a desired color display image is displayed for an observer.

### Structure of Electric Equivalent Circuit

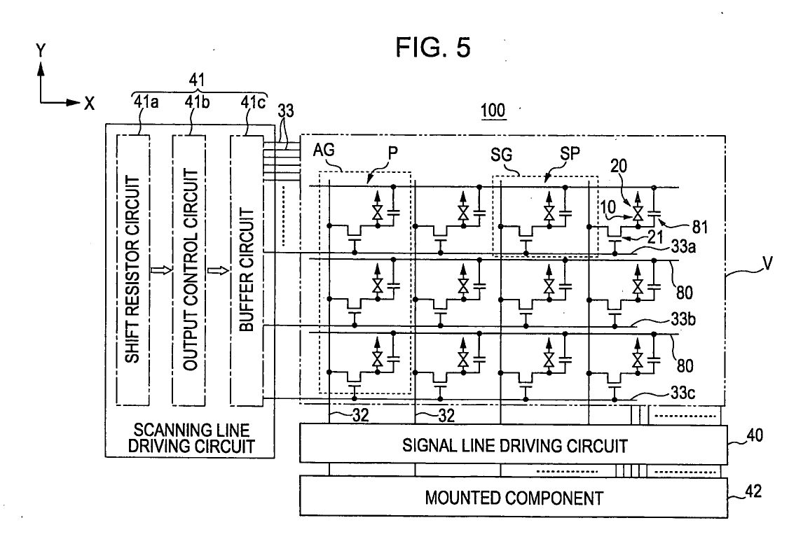

Next, a construction of the electric equivalent circuit of the liquid crystal device 100 according to the first embodiment will be described with reference to FIG. 5. FIG. 5 is a block diagram showing a structure of the electric equivalent circuit of the liquid crystal device 100. Note that the scanning line driving circuit 41 and the mounted component 42 are indeed connected to each other via the exterior connecting lines 35 but the connections are omitted in the drawings for the sake of simplicity.

The liquid crystal device 100 includes the viewing area V formed by arranging unit pixel (hereinafter, referred to as “unit pixel P”) provided in one pixel area AG in the row direction (X direction) and the column direction (Y direction) in a matrix, the signal line driving circuit 40 and the scanning line driving circuit 41 for driving each of the sub pixels (hereinafter, referred to as “sub pixel SP”) provided in each of the sub pixel areas SG, and the mounted component 42 electrically connected to the signal line driving circuit 40 and the scanning line driving circuit 41 and which is an interface between the liquid crystal device 100 and an electronic apparatus.

The liquid crystal device 100 is equipped with a plurality of gate lines 33 and commons lines 80 alternately provided at predetermined positions and a plurality of source lines 32 crossing the gate lines 33 and common lines 80 provided at a predetermined position. The unit pixel P is constructed by disposing the sub pixels SP in three rows and one column and each of the sub pixels SP is provided so as to correspond to one of the crossing positions of each of the gate lines 33 and each of the source lines 32 and each of the common lines 80 and each of the source lines 32. Note that in the invention, an supplemental capacity is formed in the third insulating film 53 which is a dielectric film provided between the pixel electrode 10 and the common electrode 20, so that it is not necessary to provide the common lines 80 and the storage capacitors 81 to be described below.

The LTPS type TFT element 21, the pixel electrode 10, the common electrode 20 being opposed to the pixel electrode 10 to sandwich the third insulating film 53 (abbreviated in the drawings), and the storage capacitor 81 electrically connected to the pixel electrode 10 and the common line 80 are provided in each sub pixel SP.

The gate line 33 is connected to the gate electrode of the LTPS type TFT element 21, the source line 32 is connected to the source electrode of the LTPS type TFT element 21, and the pixel electrode 10 and the storage capacitor 81 are connected to the drain electrode of the LTPS type TFT element 21. The liquid crystal layer 4 is sandwiched between the pixel electrode 10 and the common electrode 20. Therefore, when a selecting voltage is applied from the gate line 33, the source line 32 is made to a conductive state with the pixel electrode 10 and the storage capacitor 81 in the LTPS type TFT element 21.

The scanning line driving circuit 41 sequentially supplies a selecting voltage making the LTPS type TFT element 21 into a conducting state to each of the gate lines 33. For example, when a selecting voltage is supplied to some gate line 33, all of the LTPS type TFT elements 21 connected to the gate line 33 becomes conductive state and all the sub pixels SP related to the gate line 33 are selected. To be more specific, the scanning line driving circuit 41 includes a shift resistor circuit 41a, an output control circuit 41b, and a buffer circuit 41c, and electrical power and a variety of signals are supplied to the scanning line driving circuit 41 from an exterior circuit side of an electronic apparatus not shown in the drawings via the mounted component 42. The shift resistor circuit 41a is a sequential transfer type shift resistor, and when various signals such as a start signal VSP (start signal of one frame), a clock signal VCK, a direction signal VDIR (signal for identifying scanning direction of the gate line), and the like are supplied from an exterior circuit side of the electronic apparatus, the shift resistor circuit 41a outputs the various signals to the output control circuit 41b. The output control circuit 41b is a circuit for controlling the operation of the scanning line driving circuit 41. When a driving signal VENB supplied from a power supply circuit in an exterior circuit of an electronic apparatus is L level, the output control circuit 41b outputs a control signal which enables to select the gate line 33 to the buffer circuit 41c and outputs the various signals such as a start signal VSP, a clock signal VCK, a direction signal VDIR, and the like outputted from the shift resistor circuit 41a to the buffer circuit 41c. The buffer circuit 41c is a waveform shaping circuit for performing waveform shaping of the various signals outputted from the output control circuit 41b. Note that in the invention, a level shifter circuit for amplifying the level of the various signals outputted from the output control circuit 41b may be provided between the output control circuit 41b and the buffer circuit 41c. The scanning line driving circuit 41 having the structure described above sequentially scans the gate lines 33 whose address number is G₁, G₂, . . . , Gₘ₋₁, Gₘ, (also see FIG. 1) during one vertical scanning period (1V period) and sequentially scans three gate lines 33 during one horizontal scanning period (1H period) to drive the unit pixel P.

The signal line driving circuit 40 supplies an image signal to each of the source lines 32 and sequentially writes the image information into the pixel electrodes 10 in the sub pixel areas SG via the LTPS type TFT elements 21 which are on state.

The liquid crystal device 100 having above mentioned structure operates as described below.

That is, every sub pixel SP related to a gate line 33 is selected by line-sequentially supplying a select voltage from the scanning line driving circuit 41. Then, an image signal is supplied to the source lines 32 from the signal line driving circuit 40 in synchronization with the selection of the sub pixels SP. Thereby, the image information is supplied to every sub pixel SP selected by the scanning line driving circuit 41 and the signal line driving circuit 40 from the source lines 32 via the LTPS type TFT elements 21, and the image information is written into the pixel electrodes 10.

When the image information is written into the pixel electrode 10 in the sub pixel area SG, a driving voltage is applied to the liquid crystal layer 4 by the electric potential difference between the pixel electrode 10 and common electrode 20. Therefore, by varying a voltage level of an image signal, the alignment and regularity of the liquid crystal is changed to perform a gradation display by light modulation of each sub pixel SP.

Note that the driving voltage applied to the liquid crystal is held for three digit longer period than the period while image information is written.

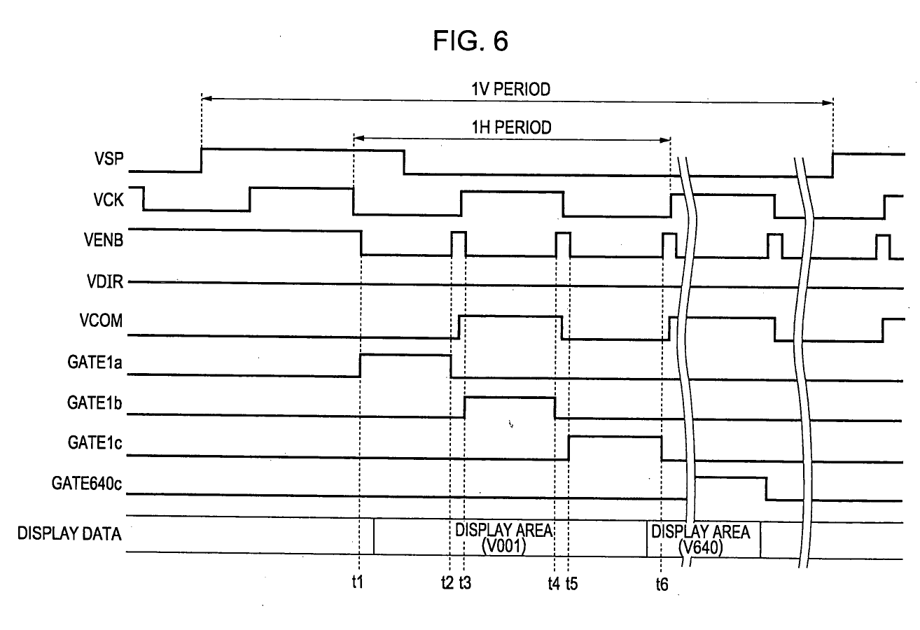

FIG. 6 shows a timing chart according to a driving method of the liquid crystal device 100.

As described above, VSP is a start signal and VCK is a clock signal, and these start signal VSP and clock signal VCK are supplied to the liquid crystal device 100 via the scanning line driving circuit 41. In addition, VENB is a driving signal and during the driving signal VENB is L level, the scanning line driving circuit 41 enables to select control signals GATE 1 to 640 (for example, when the number of the gate lines 33 is 1920) supplied to the gate lines 33.

Further, VDIR is a signal for specifying scanning direction. The direction signal VDIR is always H level in the first embodiment and scans from the left side toward the right side in FIG. 5.

As described above, the VCOM is a driving signal supplied to the common electrode 20 and the common line 80. The first embodiment employs a line reversal driving method reversing the electric potential of the common electrode 20 for every one line, so that the VCOM is reversed for every one line.

As described above, GATE is a control signal supplied to the gate line 33. In the first embodiment, the number of the gate lines 33 is, for example, 1920. GATE1a is a control signal supplied to the most upper column of gate line 33a corresponding to any address number Gₘ₋₂ in unit pixel P, GATE1b is a control signal supplied to the gate line 33b which is lower by one column than the most upper column corresponding to any address number Gₘ₋₁, and GATE1c is a control signal supplied to the most lower column of gate line 33c corresponding to any address number Gₘ. GATE640c is a control signal supplied to the most lower column of gate line 33 in the viewing area V.

DISPLAY DATA signal is a time-multiplexed image signal supplied to the signal line driving circuit 40.

Here, when focusing on 1H period, when VENB falls down from H level to L level in the state where VCOM is L level, GATE1a becomes H level during between time t1 and t2 in synchronization therewith, and a group of sub pixels SP corresponding to red (R) related to the most upper column of the gate line 33a is selected in the unit pixels P. Further, an image information corresponding to red (R) is supplied to the signal line driving circuit 40 from the exterior circuit side of an electronic apparatus via the mounted component 42 as a DATA in synchronization with the selection of the group of the sub pixels SP. The image information (V001) corresponding to red (R) is thereby supplied to the group of sub pixels SP corresponding to red (R) related to the most upper column of the gate line 33a via the source lines 32.

Subsequently, VENB becomes H level during only between time t2 and t3 and VOCM is turned over and becomes the state of H level. When VENB falls down from H level to L level at time t3, GATE1b becomes H level during between time t3 and t4 in synchronization therewith, and a group of sub pixels SP corresponding to green (G) related to the gate line 33b which is lower by one column than the most upper column is selected in the unit pixels P. Further, the image information corresponding to green (G) is supplied to the signal line driving circuit 40 from the exterior circuit side of an electronic apparatus via the mounted component 42 as a DATA in synchronization with the selection of the group of the sub pixels SP. The image information (V001) corresponding to green (G) is thereby supplied to the group of sub pixels SP corresponding to green (G) related to the gate line 33b which is lower by one column than the most upper column via the source lines 32.

Subsequently, VENB becomes H level during only between time t4 and t5 and VOCM is turned over and becomes in the state of L level. When VENB falls down from H level to L level at time t5, GATE1c becomes H level during between time t5 and t6 in synchronization therewith, and a group of sub pixels SP corresponding to blue (B) related to the most lower column of the gate line 33c is selected in the unit pixels P. Further, the image information corresponding to blue (B) is supplied to the signal line driving circuit 40 from the outer circuit side of an electronic apparatus via the mounted component 42 as a DATA in synchronization with the selection of the group of the sub pixels SP. The image information (V001) corresponding to blue (B) is thereby supplied to the group of sub pixels SP corresponding to blue (B) related to the most lower column of the gate line 33c via the source lines 32. Then, the driving control described above is further performed to GATE640a, GATE640b, and GATE640c corresponding to image information V640.

As described above, in the liquid crystal device 100, the driving method in which three sub pixels SP in a unit pixel P are sequentially scanned (that is, scanning three times) during 1H period and an image signal is supplied to each of the sub pixels SP from a same source line 32 is employed.

Next, distinctive effects of the liquid crystal device 100 according to the first embodiment as compared with the first and second comparative examples will be described.

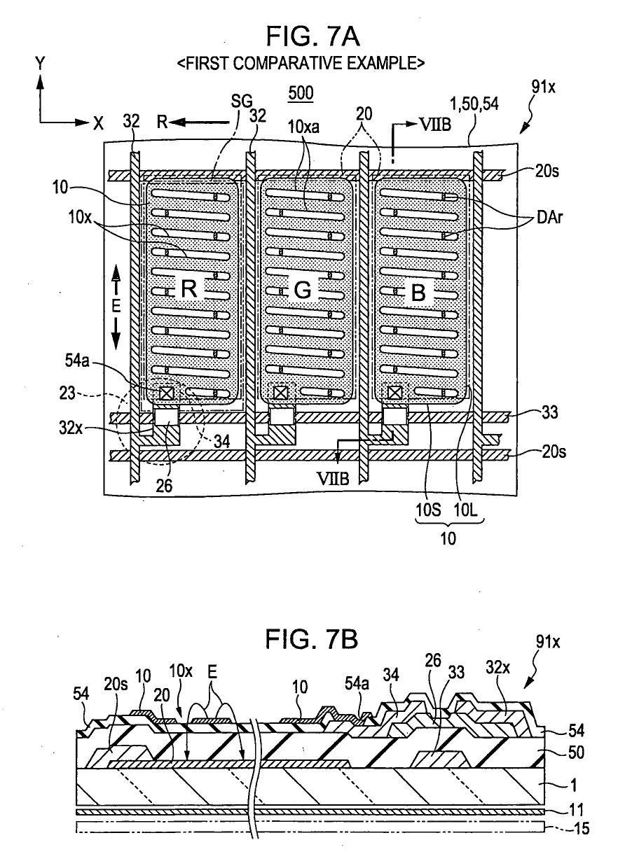

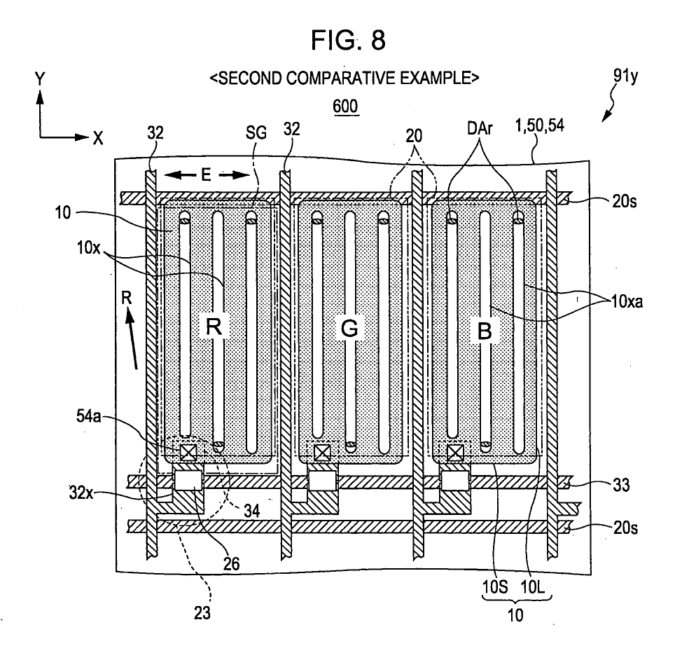

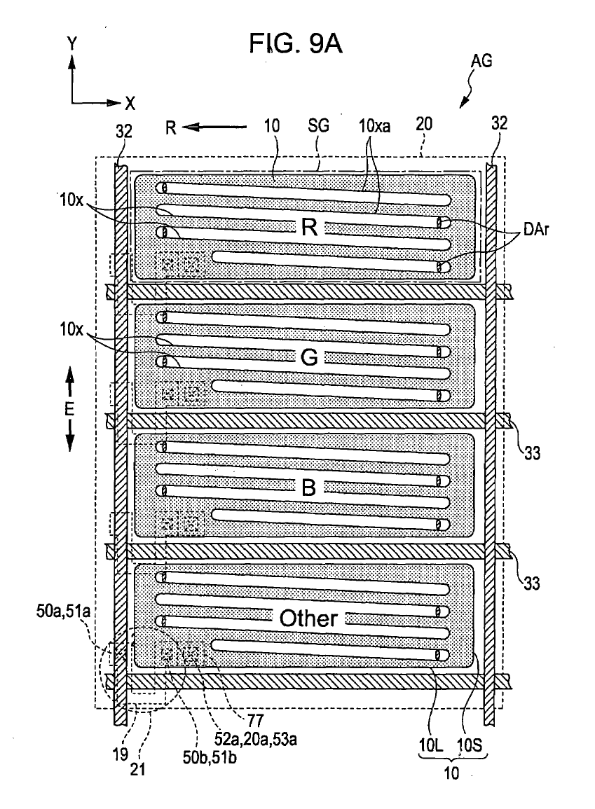

Hereinafter, a structure of an element substrate 91x of a liquid crystal device 500 of FFS system according to a first comparative example and problems thereof will be described with reference to FIGS. 7A and 7B. Subsequently, a structure of an element substrate 91y of a liquid crystal device 600 according to a second comparative example and problems thereof will be described with reference to FIG. 8. Then, distinctive effects of the first embodiment as compared with the first and second comparative examples will be described. Note that like reference numerals are attached to the same elements as the first embodiment and the descriptions thereof will be simplified or omitted.

FIG. 7A shows a planar structure of one pixel in the element substrate 91x according to the first comparative example corresponding to FIG. 2A. FIG. 7B shows a cross-sectional structure of one sub pixel in the element substrate 91x taken along the line VIIB-VIIB of FIG. 7A. Note that unlike in the case of the sub pixel area SG of the first embodiment, each sub pixel area SG1 according to the first and second comparative examples has a rectangle area having a long side in the column direction and having a short side in the row direction which is the arrangement direction of sub pixels. The direction of the long side of each sub pixel area SG1 is defined in the extending direction of the source line 32. On the other hand, the direction of the short side of each sub pixel area SG is defined in the extending direction of the gate line 33.

In the liquid crystal device 500 according to the first comparative example, liquid crystal is sealed between the element substrate 91x having α-Si type TFT elements 23 as switching elements and a color filter substrate 92 not shown to form a liquid crystal layer 4.

First, a structure of the element substrate 91x will be described as below.

A common electrode 20 (a region surrounded by a double-dashed chain line) made of ITO and the like is provided on the first substrate 1 for every sub pixel area SG. The common electrode 20 is formed in a vertically extended rectangle (vertical stripe shape) having a short side in the row direction (short side direction) of the sub pixel area SG and having a long side in the column direction (long side direction) of the sub pixel area SG. Common electrode lines 20s formed in the Y direction at a certain position and extending in the X direction is provided on a portion of the common electrode 20 and the first substrate 1 as shown in FIG. 7A. Therefore, the common electrode 20 is electrically connected to the common electrode line 20s. As is abbreviated in the drawings, the common electrode line 20s is electrically connected to the common electric potential terminal (COM terminal) at a predetermined position on the element substrate 91x. Gate lines 33 are provided so as to extend in the X direction at a certain position in the Y direction. The gate line 33 is provided in the vicinity of the common electrode line 20s provided so as to correspond to the adjacent unit pixel.

A gate insulating layer 50 is formed on the common electrode 20, the common electrode line 20s, the gate line 33 and the first substrate 1. An α-Si layer 26 which is to be a element of the α-Si type TFT element 23 is provided on the gate insulating layer 50 and in the vicinity of the crossing position of the source line 32 to be described below and the gate line 33.

Source lines 32 are provided so as to extend in the Y direction on the gate insulating film 50 in FIG. 7A. Each of the source lines 32 has a bent portion 32x which is bent so as to overlap on the α-Si layer 26 and is electrically connected to the α-Si layer 26. Further, a drain electrode 34 is provided on the α-Si layer 26 and the gate insulating film 50. Therefore, the drain electrode 34 is electrically connected to the α-Si layer 26. Therefore, the bent portion 32x of the source line 32 is electrically connected to the drain electrode 34 via the α-Si layer 26. In this manner, the α-Si type TFT element 23 is formed in the region.

A passivation layer 54 made of, for example, SᵢNₓ or the like is formed on the insulating film 50 and the α-Si type TFT element 23. The passivation layer 54 has a contact hole 54a at an overlapping position with a portion of the common electrode 20 and at an overlapping position with one end side of the drain electrode 34.

A pixel electrode 10 made of ITO or the like is formed on the passivation layer 54 for every sub pixel area SG. The pixel electrode 10 is formed in a vertically extended rectangle (vertical stripe shape) having a short side 10S in the row direction which is the alignment direction of the sub pixels and having a long side 10L in the column direction. The image electrode 10 has a plurality of slits 10x and each slit 10x is formed in an elongated horizontal strip shape and the extending direction of the long side 10xa of each slit 10x is defined in a direction making a predetermined angle to the extending direction of the short side 10S of the pixel electrode 10 and the extending direction of the gate line 33. The pixel electrode 10 is electrically connected to the drain electrode 34 via a contact hole 54a. Therefore, a source signal (image signal) from the source line 32 is supplied to the image electrode 10 via the α-Si type TFT element 23. An alignment layer not shown in the drawings is formed on the pixel electrode 10. The alignment layer is subjected to rubbing treatment in the same direction as in the first embodiment.

When the liquid crystal device 500 according to the comparative example having the structure as described above is driven, the alignment of the liquid crystal is controlled by the same principle as the liquid crystal device 100 according to the first embodiment and transparent type display is performed.

In the comparative example having the structure, there is a problem as described below.

That is, in the comparative example, as shown in FIG. 7A, the pixel electrode 10 is formed in a vertical stripe shape and each slit 10x thereof is defined in a direction making a predetermined angle to the extending direction of the short side 10S of the pixel electrode 10 and the extending direction of the gate line 33. Therefore, in the comparative example, the slits 10x needs to be evenly provided in the entire pixel electrode 10, so that the setting number of the slit 10x is increased because of the structure thereof. Here, the way in which a fringe field (electrical field E) is applied is altered in a vicinity of any one end among the two ends of the direction of the long side 10xa of each slit 10x of the pixel electrode 10 as compared with the positions which are not in the vicinity of the ends of each slit 10x, so that a domain area (alignment abnormal region of liquid crystal) DAr in which liquid crystal molecules are negligibly driven occurs. Therefore, the brightness is deteriorated in the domain area DAr resulting in a dark display region for displaying. Note that, the domain area DAr is proportional to the number of slits sets and occurs at an end of each of the slits in a staggered manner in each slit 10x which are adjacent in the Y direction. Therefore, there is a problem in that the number of the portion of the domain area DAr which does not contribute to brightness is increased as the number of the slit 10x provided in the pixel electrode 10 is increased as in the first comparative example and the transmittance of the liquid crystal device is seriously deteriorated as a result.

Therefore, for adequate driving by FFS system, if the setting number of the slit 10x provided in the pixel electrode 10 can be reduced as less as possible in the condition where the slits 10x are evenly provided in the entire pixel electrode 10x, the domain area DAr can be reduced while keeping the display state adequately and the problem described above can be improved.

Therefore, in the second comparative example, each slit 10x provided in the pixel electrode 10 is defined in the extending direction of the long side 10L of the pixel electrode 10 and in the extending direction of the source line 32 not in a direction making a predetermined angle to the extending direction of the short side 10S of the pixel electrode 10 and to the extending direction of the gate line 33 as in the first comparative example. Thereby, the length the long side 10xa of each slit 10x is elongated and the setting number of the slit 10x is reduced in the condition where the slits 10x are evenly provided in the entire pixel electrode 10.

FIG. 8 shows a planar structure of one pixel in the element substrate 91y according to the second comparative example corresponding to FIG. 7A. Note that, in the second comparative example, as shown in FIG. 8, the rubbing direction is defined in the direction of the arrow R making a predetermined angle to the extending direction of the source line 32 and the direction of the fling field (electric field E) is defined in the direction of the arrow E which is the extending direction of the gate line 33 respectively.

When the second comparative example and the first comparative example are compared, in the second comparative example, the extending direction of the long side 10xa of the slit 10x formed in the pixel electrode 10 is different form the first comparative example but other structure is the same as in the first comparative example. Note that the areas of each sub pixel area SG1 and each pixel electrode 10 are the same as in the first comparative example. In the second comparative example, as shown in FIG. 8, a domain area DAr occurs in the vicinity of any one end among the two ends of the direction of the long side 10xa of each slit 10x. However, the setting number of the slit 10x in the pixel electrode 10 is being reduced as compared with the first comparative example, so that the portion of the domain area DAr can be reduced in accordance with the reduction. As a result, there is an advantage in that the reduction of the transmittance of the liquid crystal device can be prevented in the second comparative example.

However, although such advantage can be obtained, various problems as described below may occur in the second comparative example at the same time.

That is, in the second comparative example, the extending direction of the long side 10xa of the slit 10x of the pixel electrode 10 is defined in the extending direction of the source line 32 and the slit 10x has a vertically long slit structure. Accordingly, when the vertical long slit structure is applied to a liquid crystal device having a pixel structure of High-definition, there is a problem in that the adjustment or optimization of the breadth of the slit 10x and the breadth of the electrode portion of the pixel electrode 10 positioned between adjacent slits 10x becomes difficult in design as the number of the slit 10x which can be formed in the pixel electrode 10 decreases in accordance with the reduction of the size of the sub pixel. Further, in the second comparative example, as shown in FIG. 8, the slit 10x of the pixel electrode 10 has a vertical long slit structure so that the fling field (electric field E) is generated in the extending direction of the gate line 33. Accordingly, when focusing on any sub pixels which are adjacent in the extending direction of the gate line 33, during the liquid crystal is driven, the fling field (electric field E) generated in one of the sub pixels may influence to another sub pixel, causing the liquid crystal molecules related to the another sub pixel to unnecessarily operate. Accordingly, in order to prevent the occurrence of the defect, the influence of the fringe field (electric field E) generated at the one sub pixel to the another sub pixel needs to be prevented by lengthening the distance between any sub pixels which are adjacent each other in the extending direction of the gate line 33 as large as possible. However, when such structure is employed, there is a problem in that the area of the sub pixel needs to be reduced and the aperture ratio is deteriorated in accordance with the reduction.

In consideration of the problem described above, a pixel structure as described below is employed in the first embodiment. That is, in the first embodiment, a unit pixel is composed of a plurality of sub pixels arranged in three rows and one column. Further, the pixel electrode 10 corresponding to the sub pixel is formed in a horizontally elongated rectangle (horizontal strip shape) having a long side 10L in the long side direction (row direction) of the sub pixel area SG and having a short side 10S in the short side direction (column direction) of the sub pixel area SG. In addition, the extending direction of the long side 10L of the pixel electrode 10 is defined in the extending direction of the gate line 33, on the other hand, the extending direction of the short side 10S of the pixel electrode 10 is defined in the extending direction of the source line 32. In addition, a plurality of slits 10x are formed in the pixel electrode 10 for every sub pixel area SG and each slit 10x is formed in an elongated horizontal strip shape, and the extending direction of the long side 10xa of each slit 10x is defined in a direction not the same as the extending direction of the short side 10S of the pixel electrode 10 and the extending direction of the source line 32. In the example, the extending direction of the long side 10xa of each slit 10x is defined in a direction making a predetermined angle to the extending direction of the long side 10L of the pixel electrode 10 and the extending direction of the gate line 33. In this regard, in the invention, the extending direction of the long side 10xa of each slit 10x may be defined in the same direction as the extending direction the long side 10L of the pixel electrode 10 and the extending direction of the gate line 33.

This makes it possible to reduce the setting number of the slit 10x as compared with the first comparative example in the condition where the slits 10x are evenly arranged in the entire pixel electrode 10. In the first embodiment having the structure, when the liquid crystal is driven, as shown in FIG. 2A, the domain area DAr occurs in the vicinity of any one end among the two ends of the direction of the long side 10xa of each slit 10x. However, the number of the slit 10x provided in the pixel electrode 10 is reduced, so that the portion of the domain area DAr can be reduced in accordance with the reduction. As a result, the reduction of the transmittance of the liquid crystal device 100 can be prevented.

Further, in the first embodiment, as shown in FIG. 2A the slit 10x has a horizontally elongated slit structure by defining the extending direction of the long side 10xa of the slit 10x formed in the pixel electrode 10 in approximately the same direction as the direction of the long side 10L of the pixel electrode 10. Consequently, the fringe field (electric field E) being generated between the pixel electrode 10 and common electrode 20 during driving liquid crystal is generated in the extending direction of the source line 32. However, in the first embodiment, the distance between sub pixels which are adjacent in the extending direction of the source line 32 is greater than the distance between sub pixels which are adjacent in the extending direction of the gate line 33. Accordingly, when focusing on any sub pixels which are adjacent in the extending direction of the gate line 33, the fringe field (electric field E) being generated in one of the sub pixels does not influence to another sub pixel, so that the liquid crystal molecules of the another sub pixel are not unnecessarily operated. That is, if the slit structure is employed, the mutual influence of the fringe field (electric field E) generated in each sub pixel to each sub pixel can be prevented in any sub pixels which are adjacent in the extending direction of the source line 32. Therefore, as an additional effect, the alignment disturbance of the liquid crystal is difficult to occur at the position corresponding to the source line 32, so that it is not necessary to provide the BM at the position corresponding to the source line 32.

Moreover, in the first embodiment, a unit pixel is composed of a plurality of sub pixels arranged in three rows and one column as described above. In the unit pixel, each pixel electrode 10 related to each sub pixel is electrically connected to each of the corresponding gate line 33 and is electrically commonly connected to one source line 32. Note that each sub pixel is provided so as to correspond to any one of the coloring layer 6 of red (R), green (G), or blue (B). Accordingly, three sub pixels in a unit pixel are sequentially scanned (that is, three times scanning) during 1H (one field period) and an image signal is supplied to each of the sub pixels from a same source line 32.

Therefore, a unit pixel is driven at the three times driving duty as compared with the liquid crystal device of the conventional type. As a result, improvement of display quality can be realized. Here, the liquid crystal device of the conventional type is a liquid crystal device in which a unit pixel is composed of a plurality of sub pixels arranged in one row and three columns, and equipped with a structure in which each sub pixel is electrically commonly connected to one gate line 33 and is electrically connected to each of the corresponding three source lines 32 in the unit pixel. In such liquid crystal device, three sub pixels in a unit pixel are scanned with one gate line during 1H period and an image signal is supplied to each of the sub pixels from each of the source lines 32 connected thereto.

### Second Embodiment

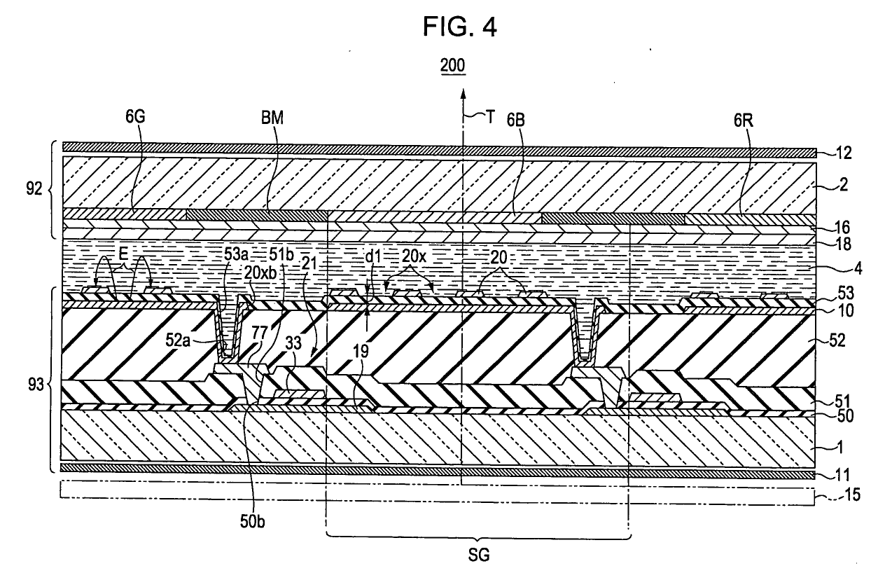

A liquid crystal device 200 according to the second embodiment of the invention will now be described with reference to FIGS. 2B and 4.

FIG. 2B shows a planar structure of one pixel in element substrate 93 according to the second embodiment. Note that only the minimum number of elements for need in description are shown in FIG. 2B. FIG. 4 shows a cross-sectional view taken along the section line IV-IV in FIG. 2B and shows a cross-sectional structure including one sub pixel when sectioned at the position which passes through the LTPS type TFT elements 21.

When the second embodiment and the first embodiment are compared, mainly the positional relationship of the common electrode 20 and the pixel electrode 10 with respect to the third insulating layer 53 which is a dielectric layer is reversed in the element substrate. However, the other structure is the same in the both embodiments. Accordingly, hereinafter, like reference numerals are attached to the same elements as the first embodiment, and the descriptions thereof will be simplified or omitted.

To be more specific, a structure of a portion of the element substrate 93 which is different from the first embodiment will be described as below.

That is, a unit pixel is composed of a plurality of sub pixels arranged in three rows and one column as in the first embodiment in the second embodiment. Each of the sub pixels (each of the pixel electrodes 10) is electrically connected to a corresponding one of the gate lines 33 and electrically connected to one source line 32 in the unit pixel. Moreover, a pixel electrode 10 is provided to have a horizontally extended shape (horizontal stripe shape) for every sub pixel SG on a second insulating film 52 which is a planarized film in the element substrate 93. The shape of the pixel electrode 10 and the positional relationship of the pixel electrode 10 and the source line 32, and the pixel electrode 10 and the gate line 33 are the same as in the first embodiment. The pixel electrode 10 is provided so as to intrude into a contact hole 52a and electrically connected to the relay electrode 77. Therefore, an image signal is supplied to the pixel electrode 10 from the source line 32 via the LTPS type TFT element 21. A third insulating film 53 which is a dielectric film is provided on the pixel electrode 10 and the second insulating film 52. A common electrode 20 is formed on the third insulating film 53 in an approximately fitted state. The common electrode 20 has a plurality of slits 20x for every sub pixel area 20 SG and each slit 20x is formed in an elongated horizontal stripe shape. The extending direction of the long side 20xa of each slit 20x is defined in a direction not the same as the direction of the short side 10S of the pixel electrode 10 and the extending direction of the source line 32. Note that in the example, the short side (reference numeral is omitted) of the each slit 20x which is linked to the long side 20xa of each slit 20x is formed to have a curved line shape. However, the shape of the short side is note limited to this in the invention and may be formed in, for example, a straight line shape. In the example, the extending direction of the long side 20xa of each slit 20x is defined in a direction making a predetermined angle with respect to the direction of the long side 10L of the pixel electrodes 10 and the extending direction of the gate line 33. note that instead of the construction, the extending direction of the long side 20xa of each slit 20x may be defined in the same direction as the direction of the long side 10L of the pixel electrode 10 and the extending direction of the gate line 33 in the invention. Moreover, the common electrode 20 has a cutout portion 20xb in the sub pixel area SG. The cutout portion 20xb is formed at one end side of one slit 20x among the plurality of slits 20x in the sub pixel area SG, the one of the slit 20x being positioned in the vicinity of the contact hole 52a, and the cutout portion 20xb is linked to the one of the slit 20x. The cutout portion 20xb is formed larger than the area of the contact hole 52a and provided at the position corresponding to the contact hole 52a.

In the second embodiment having the structure described above, a unit pixel is composed of a plurality of sub pixels arranged in three rows and one column. In addition, the pixel electrode 10 corresponding to the sub pixel is formed in a horizontally extended shape (horizontal stripe shape). Further, the common electrode 20 has a plurality of slits 20x for every sub pixel and each slit 20x is formed in an elongated horizontal stripe shape and the extending direction of the long side 20xa of each slit 20x is defined in a direction not the same as the direction of the short side 10S of the pixel electrode 10 and the extending direction of the source line 32. In the example, the extending direction of long side 20xa of each slit 20x is defined in a direction making a predetermined angle to the direction of the long side 10L of the pixel electrode 10 and the extending direction of the gate line 33.

With this structure, the setting number of the slit 20x can be reduced when compared with the comparative example in which slits 20x are evenly arranged in the entire common electrode 20 and the slit 20x provided in the common electrode 20 is defined in the same direction as the direction of the short side 10S of the pixel electrode 10 and the extending direction of the source line 32. Accordingly, in the second embodiment having the structure, the domain area DAr occurs in the vicinity of any one end among the two ends of the direction of the long side 20xa of each slit 20x during liquid crystal is driven as shown in FIG. 2B. However, the number of the slits 20x provided in the common electrode 20 is reduced as compared with the comparative example described above, so that the portion of the domain area DAr can be reduced in accordance with the reduction. As a result, reduction of the transmittance of the liquid crystal 200 can be prevented.

Further, in the second embodiment, as shown in FIG. 2B, the slit 20x is formed in a horizontally long slit structure by defining the extending direction of the long side 20xa of the slit 20x provided in the common electrode 20 in approximately the same direction as the direction of the long side 10L of the pixel electrode 10. Therefore, a fringe field (electric field E) being generated between the pixel electrode 10 and the common electrode 20 during driving of the liquid crystal generates in the extending direction of the source line 32 as in the first embodiment. However, in the second embodiment, the distance between sub pixels which are adjacent in the extending direction of the source line 32 is defined greater than the distance between sub pixels which are adjacent in the extending direction of the gate line 33 as in the first embodiment. When focusing on any sub pixels which are adjacent in the extending direction of the source line 32, the fling field (electric field E) generated in one of the sub pixel may not influence to another sub pixel, so that the liquid crystal molecules related to the another sub pixel may not be unnecessarily operated. That is, if such slit structure is employed, in any sub pixels which are adjacent in the extending direction of the source line 32, the mutual influence by the fringe field (electric field E) being generated in the each sub pixel can be prevented.

Further, in the second embodiment, a unit pixel is composed of a plurality of sub pixels arranged in three rows and one line as described above, and each sub pixel is electrically connected to a corresponding one of the gate lines 33 and electrically commonly connected to one source line 32 in the unit pixel. Note that each sub pixel is provided so as to correspond to any coloring layer 6 of red (R), green (G), or blue (B). Therefore, in the second embodiment, three sub pixels in a unit pixel are sequentially scanned (that is, three times scanning) during 1H period (one field period) and an image signal is supplied to each of the sub pixels from a same source line 32 as in the first embodiment. Consequently, the same effect can be achieved as in the first embodiment described above.

### MODIFICATIONS

In the various embodiments described above, a unit pixel is composed by three sub pixels having a horizontal stripe shape and arranged in three rows and one line, and coloring layers 6 of three colors of red (R), green (G), and blue (B) are provided at the position corresponding to each sub pixel on the color filter substrate 92 side. The invention is not limited to this and a unit pixel may by composed by N (a positive integer, hereinafter the same) sub pixels arranged in N rows and one column and having a horizontal stripe shape, and coloring layers 6 of a plurality of any colors may be provided at the position corresponding to each sub pixel on the color filter substrate 92 side. When the structure is employed, in a unit pixel, each sub pixel is electrically connected to each oh the gate lines 33 and electrically commonly connected to one source line 32, so that N sub pixels in a unit pixel are sequentially driven (that is, N times scanning) during 1H period (one field period) and an image signal is supplied to each of the sub pixels from a same source line 32. Accordingly, the unit pixel is driven at the N times driving duty as compared with the conventional type liquid crystal device described above.

For example, as for an example, a unit pixel may be composed of four sub pixels arranged in four lows and one column, and each one of coloring layers 6 of four colors of red (R), green (G), blue (B), and any color (Other) may be provided at the position corresponding to each one of the sub pixels on the color filter substrate 92 side in the invention. If the construction of the modification is employed, each sub pixel is electrically connected to a corresponding one of the gate lines 33 and electrically commonly connected to one source line 32 in a unit pixel, so that four sub pixels are sequentially scanned (that is, four times scanning) during 1H period (one field period) and an image signal is supplied to each of the sub pixels from a same source line 32. Accordingly the unit pixel is to be driven at the four times driving duty as compared with the conventional type liquid crystal device described above.

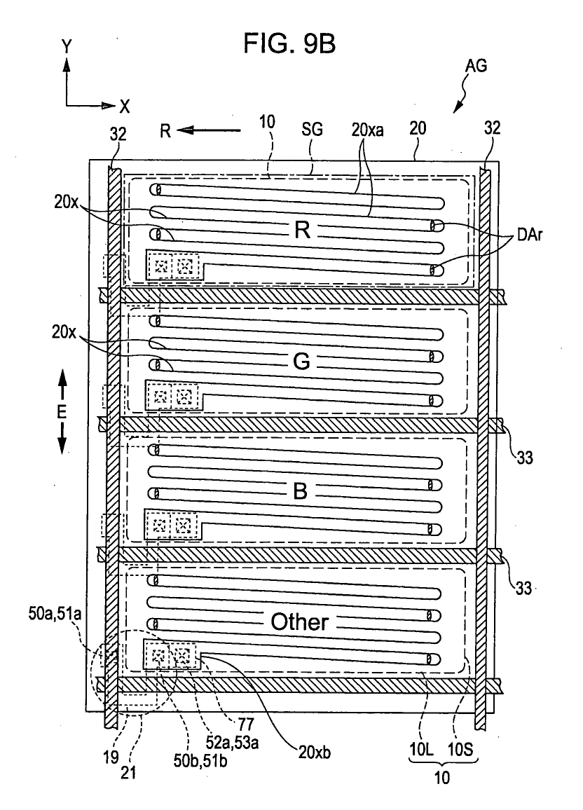

Here, a pixel formation following the fundamental structure of the first embodiment and employing the structure of the modification is shown in FIG. 9A. On the other hand, a pixel formation following the fundamental structure of the second embodiment and employing the structure of the modification is shown in FIG. 9B. With the structure, not only the effect of the invention described above can be achieved but also a display image having high color rendering not less than in the first and second embodiments can be obtained.

Further, in the invention, arrange order of the coloring layers 6 of each corresponding color is not limited in the various embodiments described above and the arrange order thereof can be freely defined.

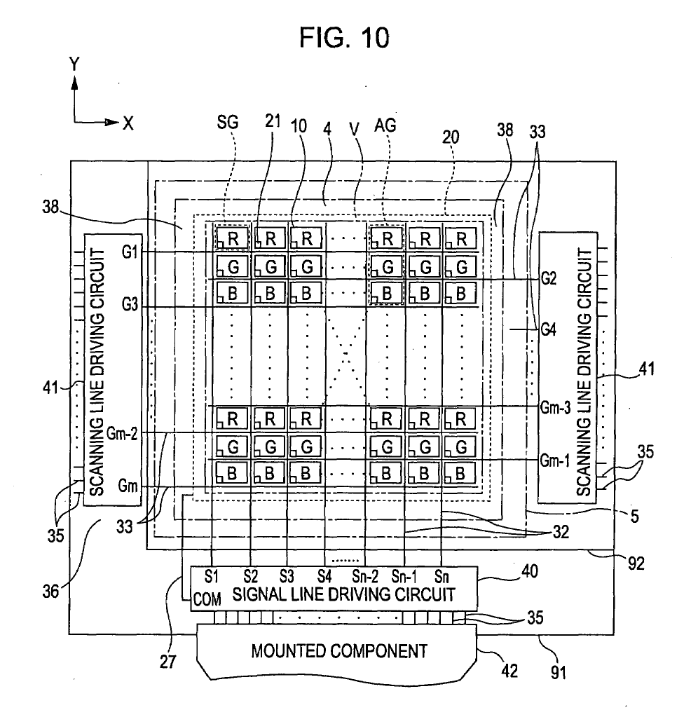

Further, in the various embodiments described above, only one scanning line driving circuit 41 is provided, and gate lines 33 are arranged so as to extend from the scanning line driving circuit 41 to the sub pixel side. However this is not limited in the invention and two scanning line driving circuits 41 may be provided so as to sandwich the viewing area V and gate lines 33 may alternatively be arranged so as to extend from each of the scanning line driving circuits 41 to the sub pixel side as shown in FIG. 10. In particular, in the case of the liquid crystal device described above in which a unit pixel is composed of four sub pixels arranged in four rows and one column, the resolution is higher than in the first and second embodiments, so that it is to be difficult to arrange gate lines 33 from one scanning line driving circuit 41 to each sub pixel side than in the first and second embodiments. In such case of a high resolution pixel structure, it is effective to provide two scanning line driving circuits 41 and to arrange gate lines 33 as described above.

Further, in the invention, the structure of the signal line driving circuit 40 is not limited to the structure of the above described first embodiment, and for example, the signal line driving circuit 40 may be constructed by a dot sequential driving circuit for sequentially writing image information into one sub pixel via the source line 32 or by various known circuits such as a demultiplexer or the like. Here, the demultiplexer refers to a circuit which has one input terminal and a plurality of output terminal and in which the plurality of output terminal are sequentially selected and connected to the input terminal by a switching element such as a transistor or the like and the image signal supplied from an image signal source as a time division signal is sorted to the source lines 32.

Further, in the invention, if there is no trouble in the time constant related to the common electrode 20, a common electrode line formed of a metal film or the like may be formed at a proper portion and the common electrode 20 may be connected to a common electric potential terminal via the common electrode line in the above described various embodiments.

In the above described various embodiments, the invention is applied to a transmission type liquid crystal device. However, the invention is not limited to this and may be applied to a reflection type liquid crystal device or a semi transmission semi reflection type liquid crystal device.

In the above described various embodiments, the invention is applied to a liquid crystal device having an LTPS type TFT element 21. However, the invention is not limited to this and may be applied to a three terminal type element, an examples of which is a P-Si type TFT elements or an α-Si type TFT elements or a two terminal type non-linear type element, an examples of which a TFD element without departing from the gist thereof.

Further, it is possible to make various modifications without departing from the gist of the invention.

### Another Embodiments

In the modifications corresponding to each of the first and second embodiments, as a coloring area of four colors, one example of the coloring area of the four colors of red (R), green (G), blue (B), and any color (Other) is described in the above description. However, the invention is not limited to this and one pixel area may be composed of a coloring area of another four colors in the invention.

In this case, the coloring area of four colors is formed by a coloring area of bluish hue (also referred to as “first coloring area”), a coloring area of reddish hue (also referred to as “second coloring area”), coloring areas of two hues selected from among hues from blue to yellow (also referred to as “third coloring area” and “fourth coloring area”) from among the visible area (from 380 to 780 nm) in which a hue is varied depending on wavelength. Here, the words “bluish” and “reddish” are used. The bluish is not limited to pure blue hue and for example, includes blue purple, blue green, and the like. The reddish hue is not limited to red and includes orange. In addition, these coloring layers may be formed by a single coloring or may be formed by overlapping a plurality of different hue coloring layers. Further, these coloring layers are described by a hue, but the hue can be set by appropriately changing chromatiness and brightness.

A concrete range of the hue is as described below.

A coloring area of bluish hue is from blue-purple to blue-green, more preferably, from deep-blue to blue.

A coloring area of reddish hue is from orange to red.

One of the coloring area selecting from blue to yellow hue is from blue to green, more preferably, from blue-green to green.

Another coloring area selecting from blue to yellow hue is from green to orange, more preferably, from green to yellow. Or from green to yellow-green.

Here, the same hue may not be used in each coloring area. For example, in the case where greenish hue is used among the two coloring areas selected from blue to yellow hue, bluish hue or yellow-greenish hue is used with respect to the green one in another coloring area.

Thereby a wide range of color reproducibility wider than the conventional RGB coloring area can be provided.

In the above description, a wide range of color reproducibility by a coloring area of four colors hue is described by a hue. However, the coloring area is also expressed by the wavelength of the light which transmits the coloring area as described below.

A coloring area of bluish is a coloring area in which the peak of the wavelength of the light which transmits the coloring area is from 415 to 500 nm, preferably from 435 to 485 nm.

A coloring area of reddish is a coloring area in which the peak of the wavelength of the light which transmits the coloring area is not less than 600 nm, preferably not less than 605 nm.

One of the coloring area selected from blue to yellow hue is a coloring area in which the peak of the wavelength of the light which transmits the coloring area is from 485 to 535 nm, preferably from 495 to 520 nm.

Another coloring area selected from blue to yellow hue is a coloring area in which the peak of the wavelength of the light which transmits the coloring area is from 500 to 590 nm, preferably from 510 to 585 nm or from 530 to 565 nm.

The numeric values of the wavelength are obtained by the illumination light from an illumination device which passes through a color filter in the case of transmission display and by the reflection of an outside light in the case of reflection display.

Further, the coloring area of four colors hue will be expressed by an x-y chromaticity diagram as described below.

A coloring area of bluish is the coloring area in x≦0.151, y≦0.200, preferably, 0.134≦x≦0.151, 0.034≦y≦0.200.

A coloring area of reddish is the coloring area in 0.520≦x, y≦0.360, preferably, 0.550≦x≦0.690, 0.210≦y≦0.360.

One of the coloring area selected from blue to yellow hue is the coloring area in x≦0.200, 0.210≦y, preferably, 0.080≦x≦0.200, 0.210≦y≦0.759.

Another coloring area selected from blue to yellow hue is the coloring area in 0.257≦x, 0.450≦y, preferably, 0.257≦x≦0.520, 0.450≦y≦0.720.

The numeric numbers in the x-y chromaticity diagram are obtained by the illumination light from an illumination device which passes through a color filter in the case of transmission display and by the reflection of an outside light in the case of reflection display.

In the case where a transmission area and a reflection area are equipped in a sub pixel, the transmission area and the reflection area can also be applied to the four colors coloring area within the range described above.

Note that in the case where the four color hues coloring area in the present example is used, an LED (Light Emitting Diode), a fluorescent tube, an organic EL (organic electroluminescence), or the like may be used as an RGB light source as described above as a backlight (illumination device). Instead, a white color light source may be used. Note that the white color light source may be generated by a blue illuminator and a YAG system fluorescent material.

In this regard, a preferred RGB light source is as described below.

The peak of the wavelength of the light emitted from B light source ranges from 435 nm to 485 nm.

The peak of the wavelength of the light emitted from G light source ranges from 520 nm to 545 nm.

The peak of the wavelength of the light emitted from R light source ranges from 610 nm to 650 nm.

Then, a wide range of color reproducibility can be obtained by appropriately selecting the coloring layers described above by the wavelengths of RGB light sources. In addition, a light source having a plurality of peaks, for example, at 450 nm and 565 nm in wavelength may be used.

As a structure of the coloring area of four color hues described above, concrete examples will be exemplified below.

The coloring area of red, blue, green, and cyan (blue-green) hue.

The coloring area of red, blue, green, and yellow hue.

The coloring area of red, blue, dark green, and yellow hue.

The coloring area of red, blue, emerald green, and yellow-green hue.

The coloring area of red, blue, emerald green, and yellow hue.

The coloring area of red, blue, dark green, and yellow-green hue.

### Electronic Apparatus

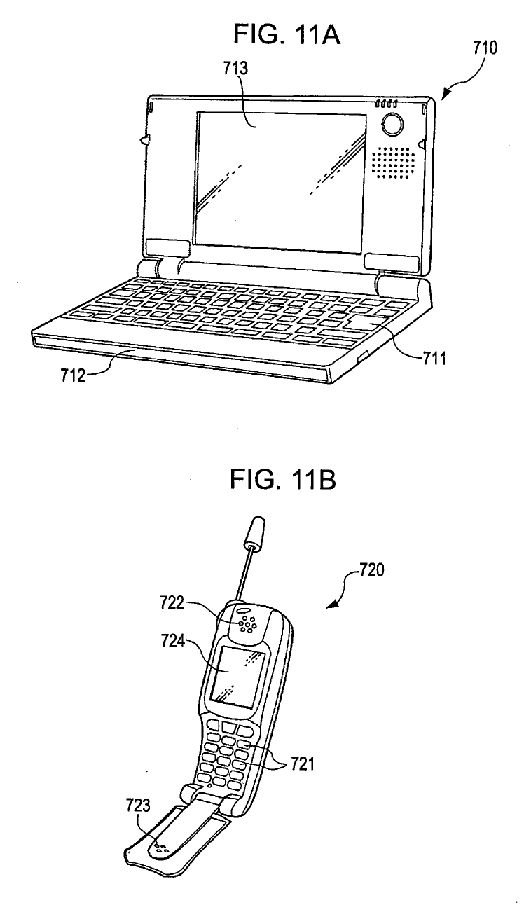

Next, a specific example of the electronic apparatus to which the liquid crystal device according to various embodiments described above can be applied will be described with referent to FIG. 11.

First, an example will be described in which the liquid crystal device according to various embodiments described above is applied to a display unit of a portable personal computer (so-called notebook computer). FIG. 11A is a perspective view illustrating the structure of the personal computer. As shown in FIG. 11A, the personal computer 710 is provided with a main body unit 712 including a keyboard 711 and a display unit 713 to which the liquid crystal device according to the invention is applied as a panel.

Further, an example will be described in which the liquid crystal device according to various embodiments described above is applied to a display section of a mobile phone. FIG. 11B is a perspective view illustrating the structure of the mobile phone. As shown in FIG. 11B, the mobile phone 720 is provided with a plurality of operation buttons 721, an earpiece 722, a mouthpiece 723 and a display unit 724 to which the liquid crystal device according to various embodiments described above is applied.

Note that as an electronic apparatus to which the liquid crystal device according to various embodiments described above can be applied, a liquid crystal television, a view-finder-type or monitor-direct-view-type vide tape recorder, a car navigation device a pager, an electronic note, an electric calculator, a word processor, a work station, a video phone, a POS terminal, a digital still camera, and the like are exemplified in addition to the personal computer shown in FIG. 11A and the mobile phone shown in FIG. 11B.

The entire disclosure of Japanese Patent Application No. 2006-74774, filed Mar. 17, 2006 is expressly incorporated by reference herein

What is claimed is:

1. A liquid crystal device comprising:
a substrate including unit pixels each composed of a plurality of sub pixels arranged in a plurality of rows and one column and having a long side in the row direction and a short side in the column direction, wherein
the substrate includes switching elements, an insulating film provided on at least the upper side of each of the switching elements, at least one first transparent electrodes provided on the upper side of the insulating film, other insulating film provided on the upper side of the first transparent electrodes, and at least one second transparent electrode formed on the upper side of the other insulating film and having a plurality of slits formed for each of the sub pixels and generating an electric field, the electric field being generated between the first transparent electrode and the second transparent electrode through each of the slits, and
the extending direction of the long side of each of the slits is defined in a direction not the same as the extending direction of the short side of the sub pixels.

2. The liquid crystal device according to claim 1, wherein the extending direction of the long side of the slits is defined in the same direction as the extending direction of the long side of the sub pixels or in a direction making a predetermined angle with respect to the extending direction of the long side of the sub pixels.

3. The liquid crystal device according to claim 1, further comprising a plurality of first lines extending in the column direction and a plurality of second lines extending in the row direction which are electrically connected to the switching elements, and
wherein the extending direction of the long side of the each slit is defined in the same direction as the extending direction of the plurality of second lines or in a direction making a predetermined angle with respect to the extending direction of the plurality of second lines.

4. The liquid crystal device according to claim 1, wherein the first transparent electrode is a common electrode connected to a common electric potential, and the second transparent electrode is a unit sub pixel electrode formed for each of the sub pixels and electrically connected to the switching element via a contact hole provided in each of the insulating film and the other insulating film.

5. The liquid crystal device according to claim 1, wherein the first transparent electrode is a unit sub pixel electrode formed for each of the sub pixels and electrically connected to the switching element via a contact hole provided in the insulating film, and the second transparent electrode is a common electrode connected to a common electric potential.

6. The liquid crystal device according to claim 3, wherein the plurality of first lines are a plurality of source lines electrically connected to a signal line driving circuit and to which an image signal is supplied from the signal line driving circuit, and the plurality of second lines are a plurality of gate lines electrically connected to a scanning line driving circuit and to which a scanning signal is supplied from the scanning line driving circuit,
each of the sub pixels constituting the unit pixels is electrically connected to a corresponding one of the gate lines and electrically commonly connected to one of the source lines, and
the scanning line driving circuit drives the unit pixels by sequentially scanning each of the gate lines electrically connected to each of the sub pixels during one horizontal scanning period.

7. The liquid crystal device according to claim 1, wherein the electric field has strong electric field components in the direction approximately parallel to and in the direction approximately perpendicular to the substrate.

8. An electronic apparatus comprising the liquid crystal device according to claim 1 as a display unit.
